(19) United States
(12) Patent Application Publication
(10) Pub. No.: US 2025/0046308 A1
(43) Pub. Date: Feb. 6, 2025

(54) SPEECH CONTROL METHOD, MULTIMEDIA SYSTEM, VEHICLE, AND STORAGE MEDIUM

(71) Applicant: BYD COMPANY LIMITED, SHENZHEN (CN)

(72) Inventors: Hang YAN, Shenzhen (CN); Dongsheng YANG, Shenzhen (CN); Biying ZHANG, Shenzhen (CN); Ke LIU, Shenzhen (CN)

(21) Appl. No.: 18/917,879

(22) Filed: Oct. 16, 2024

Related U.S. Application Data
(63) Continuation of application No. PCT/CN2023/095840, filed on May 23, 2023.

(30) Foreign Application Priority Data
Jun. 30, 2022 (CN) 202210759453.7

(51) Int. Cl. G10L 15/22; G10L 15/08; G10L 15/18

(52) U.S. Cl. CPC G10L 15/22; G10L 15/1815; G10L 2015/088; G10L 2015/223

(57) ABSTRACT

A speech control method includes: receiving a target voice instruction; performing semantic parsing on the target voice instruction, and acquiring a semantic parsing result; and in response to that the semantic parsing result matches a keyword, responding to the target voice instruction by using an application corresponding to the keyword; or in response to that the semantic parsing result does not match a keyword, determining a target service type based on the semantic parsing result, and acquiring an application list corresponding to the target service type; determining a recommended application from the application list by using a first recommendation policy; and responding to the target voice instruction by using the recommended application.

### CROSS-REFERENCE TO RELATED APPLICATIONS

This application is a continuation application of International Patent Application No. PCT/CN2023/095840, filed on May 23, 2023, which is based on and claims priority to and benefits of Chinese Patent Application No. 202210759453.7, filed on Jun. 30, 2022. The entire content of all of the above-referenced applications is incorporated herein by reference.

### FIELD

The present disclosure relates to the field of voice processing technologies, and in particular, to a voice control method, a multimedia system, a vehicle, and a storage medium.

### BACKGROUND

With rapid development of Internet and vehicle technologies, a user can use an in-vehicle multimedia system to surf online. Multiple applications (for example, KuGou and Kuwo) of a same type are installed on an existing in-vehicle multimedia system. When the user generates a voice instruction, the system directly invokes a default application to respond, and the default application is not an application preferred by the user, so that user experience is poor.

### SUMMARY

Embodiments of the present disclosure provide a voice control method, a multimedia system, a vehicle, and a storage medium.

An embodiment of the present disclosure provides a voice control method, including:
receiving, by a processor of a voice control system, a target voice instruction;
performing, by the processor, semantic parsing on the target voice instruction, and acquiring a semantic parsing result; and
in response to that the semantic parsing result matches a keyword, responding, by the processor, to the target voice instruction by using an application corresponding to the keyword; or
in response to that the semantic parsing result does not match a keyword, determining, by the processor, a target service type based on the semantic parsing result, and acquiring, by the processor, an application list corresponding to the target service type; determining, by the processor, a recommended application from the application list by using a first recommendation policy; and responding, by the processor, to the target voice instruction by using the recommended application.

According to an embodiment of the present disclosure, that a recommended application is determined from the application list by using a first recommendation policy includes:

A foreground application is determined as the recommended application in response to that the application list includes the foreground application.

A background application is determined as the recommended application in response to that the application list does not include the foreground application and the application list includes the background application.

In response to that the application list does not include the foreground application and the background application and a recently used application, the recommended application is determined from the application list by using a second recommendation policy.

A preset application is determined as the recommended application in response to that the application list does not include the foreground application, the background application, and the recently used application.

The recently used application includes an application used in a period before a current moment.

According to an embodiment of the present disclosure, that the recommended application is determined from the application list by using a second recommendation policy includes:

A target content type is determined based on the semantic parsing result, and whether the recently used application includes content corresponding to the target content type is determined.

The recently used application is determined as the recommended application in response to that the recently used application includes the content corresponding to the target content type.

In response to that the recently used application does not include the content corresponding to the target content type, whether a candidate application of the content corresponding to the target content type exists is determined.

The candidate application is determined as the recommended application in response to that the candidate application including the content corresponding to the target content type exists.

The preset application is determined as the recommended application in response to that the candidate application including the content corresponding to the target content type does not exist.

According to an embodiment of the present disclosure, that the target voice instruction is responded to by using the recommended application includes:

The target content type is determined based on the semantic parsing result, and whether the recommended application includes the content corresponding to the target content type is determined.

In response to that the recommended application includes the content corresponding to the target content type, the target voice instruction is responded to by using the recommended application.

In response to that the recommended application does not include the content corresponding to the target content type, a candidate application including the target content type is obtained to be the recommended application, and the target voice instruction is responded to by using the recommended application.

According to an embodiment of the present disclosure, that a candidate application including the target content type is updated to be the recommended application includes:

The candidate applications are determined, and an advantageous content type of each of the candidate applications is acquired.

A first application having an advantageous content type that is the target content type is selected as the recommended application.

According to an embodiment of the present disclosure, the semantic parsing result includes the target content type.

That the target voice instruction is responded to by using the recommended application includes:

An advantageous content type corresponding to the recommended application is acquired, and matching is performed on the advantageous content type corresponding to the recommended application and the target content type.

In response to that the advantageous content type corresponding to the recommended application matches the target content type, the target voice instruction is responded to by using the recommended application.

In response to that the advantageous content type corresponding to the recommended application does not match the target content type, advantageous content recommendation information is acquired, the target voice instruction is responded to by using the recommended application, and the advantageous content recommendation information is prompted.

According to an embodiment of the present disclosure, that advantageous content recommendation information is acquired includes:

Candidate applications other than the recommended application in the application list is determined as second applications, and an advantageous content type corresponding to each of the second applications is acquired.

The advantageous content recommendation information is acquired based on the advantageous content type corresponding to each of the second applications and the target content type.

According to an embodiment of the present disclosure, that the advantageous content recommendation information is acquired based on the advantageous content type corresponding to each of the second applications and the target content type includes:

Similarity calculation is performed on the advantageous content type corresponding to each of the second applications and the target content type, to acquire a content type similarity corresponding to each of the second applications.

A second application with a highest content type similarity is determined as a target application from the second applications.

The advantageous content recommendation information is acquired based on the target application.

In an embodiment, the application list includes at least one candidate application, and each candidate application includes at least one current content type.

Before that the target voice instruction is responded to by using the recommended application, the voice control method further includes:

Current traffic and a current user rating that correspond to each current content type in the candidate application are acquired.

An overall rating corresponding to the current content type is acquired based on the current traffic and the current user rating that correspond to each current content type.

An advantageous content type of the candidate application is determined based on an overall rating corresponding to the at least one current content type.

An embodiment of the present disclosure provides a multimedia system, including a memory, a processor, and a computer program stored in the memory and executed on the processor. The voice control method is implemented when the processor executes the computer program.

An embodiment of the present disclosure provides a vehicle, including the multimedia system.

An embodiment of the present disclosure provides a non-transitory computer-readable storage medium, storing a computer program. The voice control method is implemented when the computer program is executed by a processor.

### BRIEF DESCRIPTION OF THE DRAWINGS

To describe technical solutions in embodiments of the present disclosure more clearly, the following briefly describes accompanying drawings required for describing the embodiments of the present disclosure. The accompanying drawings in the following descriptions show some embodiments of the present disclosure, and a person of ordinary skill in the art may still derive other drawings from these accompanying drawings without creative efforts.

FIG. 1 is a schematic diagram of an application environment of a voice control method according to an embodiment of the present disclosure;

FIG. 2 is a flowchart of a voice control method according to an embodiment of the present disclosure;

FIG. 3 is another flowchart of a voice control method according to an embodiment of the present disclosure;

FIG. 4 is another flowchart of a voice control method according to an embodiment of the present disclosure;

FIG. 5 is another flowchart of a voice control method according to an embodiment of the present disclosure;

FIG. 6 is another flowchart of a voice control method according to an embodiment of the present disclosure;

FIG. 7 is another flowchart of a voice control method according to an embodiment of the present disclosure;

FIG. 8 is another flowchart of a voice control method according to an embodiment of the present disclosure;

FIG. 9 is another flowchart of a voice control method according to an embodiment of the present disclosure;

FIG. 10 is another flowchart of a voice control method according to an embodiment of the present disclosure; and

FIG. 11 is another flowchart of a voice control method according to an embodiment of the present disclosure.

### DETAILED DESCRIPTION

The following clearly describes technical solutions in embodiments of the present disclosure with reference to accompanying drawings in the embodiments of the present disclosure. Clearly, the described embodiments are some of the embodiments of the present disclosure rather than all of the embodiments. Some embodiments acquired by a person of ordinary skill in the art based on the embodiments of the present disclosure without creative efforts shall fall within the protection scope of the present disclosure.

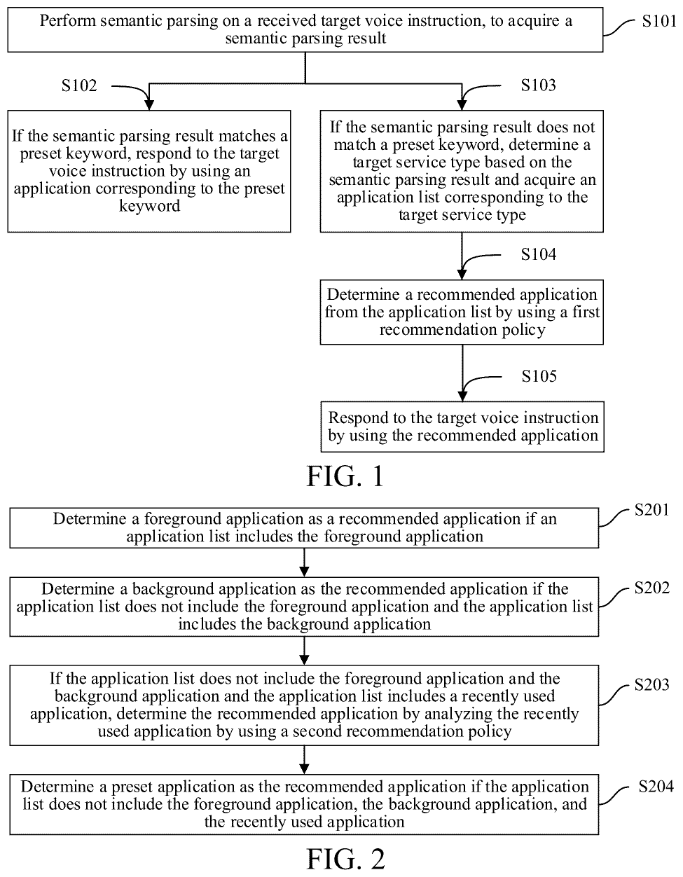

The embodiments of the present disclosure provide a voice control method. The voice control method may be applied to an application environment shown in FIG. 1. In some embodiments, the voice control method is applied to a voice control system (briefly referred to as a “system” below). The voice control system may be a multimedia system on a vehicle (that is, an in-vehicle infotainment system), or may be another system that can implement voice control. The voice control system may invoke an application that meets a user preference to respond based on a collected target voice instruction input by a user, to improve user experience.

In an embodiment, a voice control method is provided. As shown in FIG. 1, the voice control method executed by a processor includes the following steps.

S101: Semantic parsing is performed on a received target voice instruction, to acquire a semantic parsing result.

S102: If the semantic parsing result matches a preset keyword, the target voice instruction is responded to by using an application corresponding to the preset keyword.

S103: If the semantic parsing result does not match a preset keyword, a target service type is determined based on the semantic parsing result and an application list corresponding to the target service type is acquired.

S104: A recommended application is determined from the application list by using a first recommendation policy.

S105: The target voice instruction is responded to by using the recommended application.

The target voice instruction is an instruction that is input by a user in a voice manner and that indicates an application to work. The semantic parsing result is a result of semantic parsing performed on the target voice instruction.

In an example, in step S101, a multimedia system may receive the target voice instruction input by the user, and invoke a preset voice recognition tool of the system to perform semantic parsing on the target voice instruction to acquire the semantic parsing result. A processing process of the target voice instruction includes a voice recognition process and a semantic parsing process. The voice recognition tool may be any tool for implementing semantic parsing, including but not limited to an iFLYTEK voice recognition tool. For example, the multimedia system may receive a target voice instruction, for example, “play crosstalk”, “I want to hear financial news”, “I want to hear ghost stories”, “pop music”, or “play a movie”, input by the user in a voice form, and perform semantic parsing on the target voice instruction to acquire a semantic parsing result in a text form.

The preset keyword is a preset keyword bound to an application.

In an example, in step S102, after acquiring the semantic parsing result, the multimedia system may perform matching on the semantic parsing result and the preset keyword. When the semantic parsing result matches the preset keyword, the application corresponding to the preset keyword may be directly used to respond to the target voice instruction. For example, if the multimedia system acquires a semantic parsing result “I want to open Tencent Video”, and the semantic parsing result matches a preset keyword “Tencent Video” preset in the system, the multimedia system responds to the target voice instruction by using an application “Tencent Video APP”. Because a user preference can be intuitively reflected when the semantic parsing result matches the preset keyword, directly using the application corresponding to the preset keyword to respond to the target voice instruction meets the user preference, improves user experience, and further improves a user retention rate.

The target service type is a corresponding service type, in the semantic parsing result, that reflects a function to which an utterance of the user belongs. The application list is a list formed by at least one candidate application. The candidate application is an application that can display content corresponding to the target service type.

In an example, in step S103, after acquiring the semantic parsing result, the multimedia system may perform matching on the semantic parsing result and the preset keyword. When the semantic parsing result does not match the preset keyword, the multimedia system may determine the target service type based on the semantic parsing result, then query, based on the target service type, the at least one candidate application including the target service type in the system, and acquire the application list based on the at least one candidate application. In this example, the multimedia system acquires, from the semantic parsing result, field information corresponding to a service type field, and determines the field information as the target service type. For example, the semantic parsing result acquired through parsing by using the voice recognition tool includes field information corresponding to a service field, and the field information corresponding to the service field is determined as the target service type. The service field is used to reflect the service type corresponding to the function to which the utterance of the user belongs, including but not limited to “air conditioner=Aircontrol”, “navigation=Map”, “music=Music”, and “radio station=internetRadio”.

The first recommendation policy is a preset policy used to determine a recommended application based on a service type. The recommended application is an application recommended for use by the user.

In an example, in step S104, after determining the application list corresponding to the target service type based on the target service type, the multimedia system may invoke the preset first recommendation policy to select an application that best complies with a user preference from the application list, and determine the application as the recommended application. In this example, the first recommendation policy may be used to analyze the user preference based on user behavior or other information, to determine a processing policy of the recommended application that matches the user preference.

In an example, in step S105, after determining the recommended application, the multimedia system responds to the target voice instruction by using the recommended application, for example, may play audio based on the recommended application. It may be understood that, because the recommended application meets the user preference to a certain extent, using the recommended application to respond to the target voice instruction can improve user experience, and further improve a user retention rate.

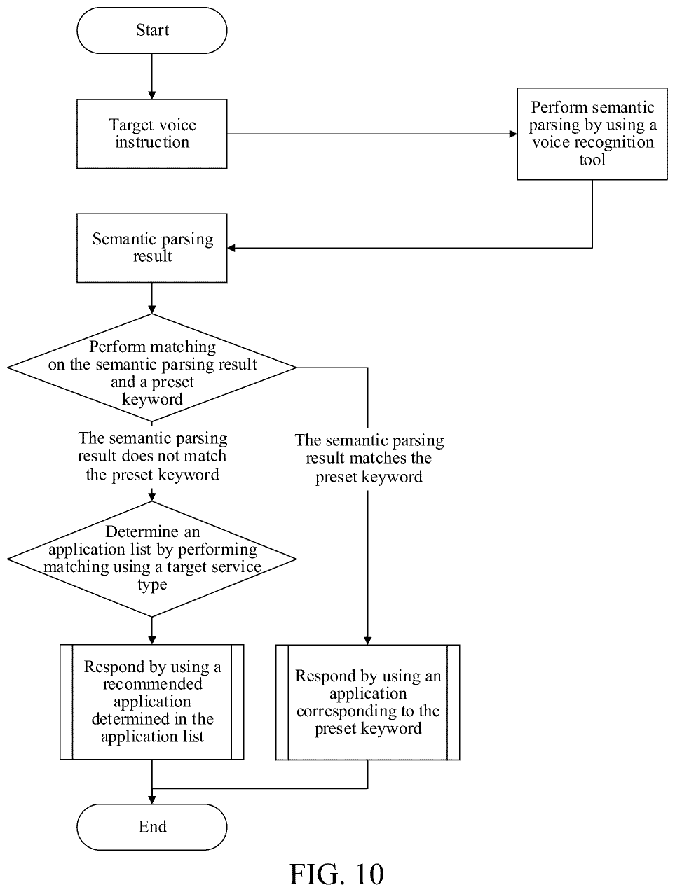

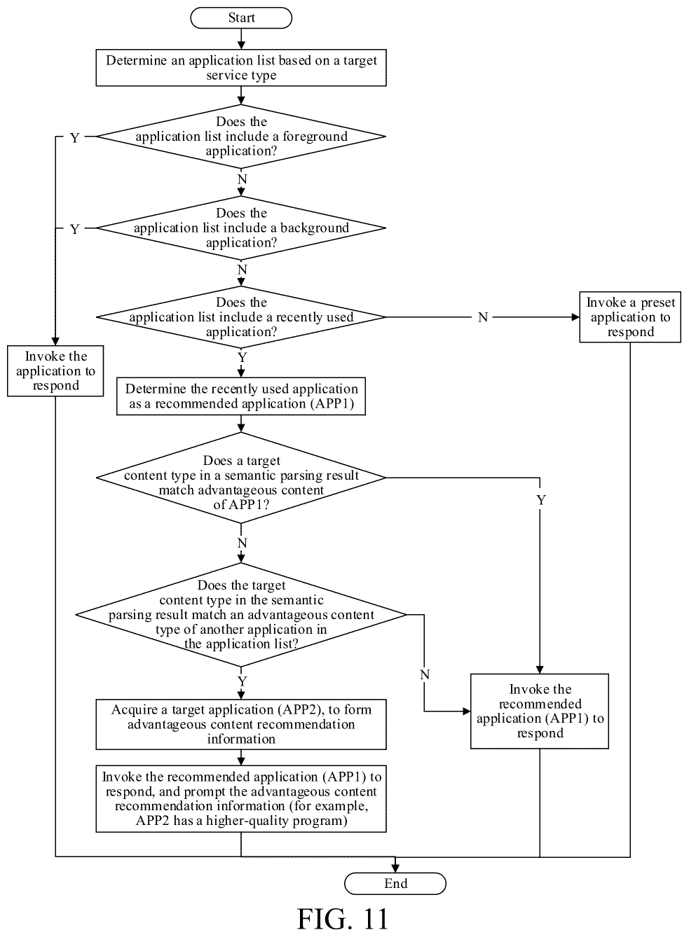

As shown in FIG. 10, after receiving the target voice instruction, the multimedia system may invoke the voice recognition tool to perform semantic parsing on the target voice instruction, to acquire the semantic parsing result. Then, matching is performed on the semantic parsing result and the preset keyword. If the semantic parsing result matches the preset keyword, the application corresponding to the preset keyword is used to respond to the target voice instruction. If the semantic parsing result does not match the preset keyword, content of the service field in the semantic parsing result is determined as the target service type, then the application list corresponding to the target service type is acquired, the recommended application is determined from the application list, and the recommended application is used to respond to the target voice instruction, so that a response process of the target voice instruction meets the user preference, can improve the user experience, and further improve the user retention rate.

In this embodiment, when the semantic parsing result matches the preset keyword, the user preference can be intuitively reflected. Therefore, the application corresponding to the preset keyword may be used to respond to the target voice instruction. This helps improve the user experience, and further improve the user retention rate. When the semantic parsing result does not match the preset keyword, the recommended application is determined from the application list corresponding to the target service type, and the recommended application is used to respond to the target voice instruction. This can meet the user preference to a certain extent, improve the user experience, and further improve the user retention rate.

In an embodiment, the application list includes the at least one candidate application corresponding to the same target service type.

Step S104, in some embodiments, that a recommended application is determined from the application list by using a first recommendation policy includes: The recommended application is determined from the at least one candidate application by using the first recommendation policy.

The application list is a list formed by the at least one candidate application. The candidate application is an application that can display the content corresponding to the target service type. In this example, the application list includes the at least one candidate application corresponding to the same target service type.

In an example, after determining the application list corresponding to the target service type based on the semantic parsing result, the multimedia system may determine the at least one candidate application from the application list, then execute the preset first recommendation policy to analyze the at least one candidate application, screen out a recommended application that best meets the user preference from the at least one candidate application, and determine the recommended application as the recommended application, to respond to the target voice instruction by using the recommended application, so that the user can browse content of interest by using the recommended application, and therefore the user retention rate is improved.

In this embodiment, the application list corresponding to the target service type includes the at least one candidate application corresponding to the same target service type. The candidate application is an application that meets a basic user requirement (that is, the target service type) extracted from the semantic parsing result. Then, the recommended application that best meets the user preference is screened out from the at least one candidate application, so that when the recommended application is used to respond to the target voice instruction, the user preference is better complied with, to improve the user retention rate.

In an embodiment, as shown in FIG. 2, step S104, that a recommended application is determined from the application list by using a first recommendation policy includes the following steps.

S201: A foreground application is determined as the recommended application if the application list includes the foreground application.

S202: A background application is determined as the recommended application if the application list does not include the foreground application and the application list includes the background application.

S203: If the application list does not include the foreground application and the background application and the application list includes a recently used application, the recommended application is determined by analyzing the recently used application by using a second recommendation policy.

S204: A preset application is determined as the recommended application if the application list does not include the foreground application, the background application, and the recently used application.

The recently used application is an application that has been used in a preset period before a current moment.

The foreground application is an application running in the foreground at the current moment, in other words, an application that is running and that is visible to the user. The background application is an application running in the background at the current moment, in other words, an application that can continue to slightly run a related service after the application is closed. The recently used application is an application that has been used in the preset period before the current moment. The preset period is a user-defined period, and may be one day or one week. The preset application is an application that is set by default other than the foreground application, the background application, and the recently used application, and may be a system-provided application.

In an example, in step S201, after acquiring the application list, the multimedia system needs to determine whether the application list includes the foreground application. If the application list includes the foreground application, it indicates that a candidate application is running in the foreground at the current moment, and the user is browsing the foreground application. This may reflect that the user prefers the foreground application. Therefore, the foreground application may be determined as the recommended application. In this way, a recommended application with a highest user preference degree is acquired.

In an example, in step S202, when the application list does not include the foreground application, the multimedia system determines whether the application list includes the background application. If the application list includes the background application, it indicates that although no candidate application is running in the foreground at the current moment, a candidate application is running in the background at the current moment. The background application may be understood as an application opened before the current moment and not completely closed. This may also reflect that the user prefers the background application to a certain extent. Therefore, the background application may be determined as the recommended application. In this way, a recommended application with a high user preference degree is acquired.

The second recommendation policy is a preset policy used to analyze the recently used application to determine the recommended application.

In an example, in step S203, when the application list does not include the foreground application and the background application, the multimedia system determines whether the application list includes the recently used application. If the application list includes the recently used application, it indicates that although no candidate application is running in the foreground and the background at the current moment, the recently used application runs before the current moment and a running record is buffered. This may reflect that the user has browsed the recently used application and prefers the recently used application. Therefore, the second recommendation policy is used to analyze the recently used application, to determine the recommended application. In this way, a recommended application with a common user preference degree is acquired. In this example, the second recommendation policy is used to analyze the recently used application, and a recently used application that meets a preset condition may be determined as the recommended application. The preset condition herein is a condition that is set in advance, and may be determined based on the user preference.

In an example, in step S204, when the application list does not include the foreground application, the background application, and the recently used application, the multimedia system may determine, as the recommended application, the preset application that is set by the system by default. The preset application is any one of the candidate application, and corresponds to the target service type. In this way, a recommended application that meets the basic user requirement is acquired.

As shown in FIG. 10, the multimedia system first determines whether the application list includes the foreground application. If the foreground application is included, the foreground application is used as the recommended application to respond to the target voice instruction. If the foreground application is not included, whether the application list includes the background application is then determined. If the background application is included, the background application is used as the recommended application to respond to the target voice instruction. If the background application is not included, whether the application list includes the recently used application is determined. If the recently used application is included, the recommended application needs to be further determined by using the second recommendation policy. If the recently used application is not included, the preset application is determined as the recommended application to respond to the target voice instruction.

In this embodiment, selection is performed sequentially from the foreground application, the background application, the recently used application, and the preset application in descending order of user preference degrees, to determine the recommended application, so that using the recommended application to respond to the target voice instruction better complies with the user preference, and further improves the user retention rate.

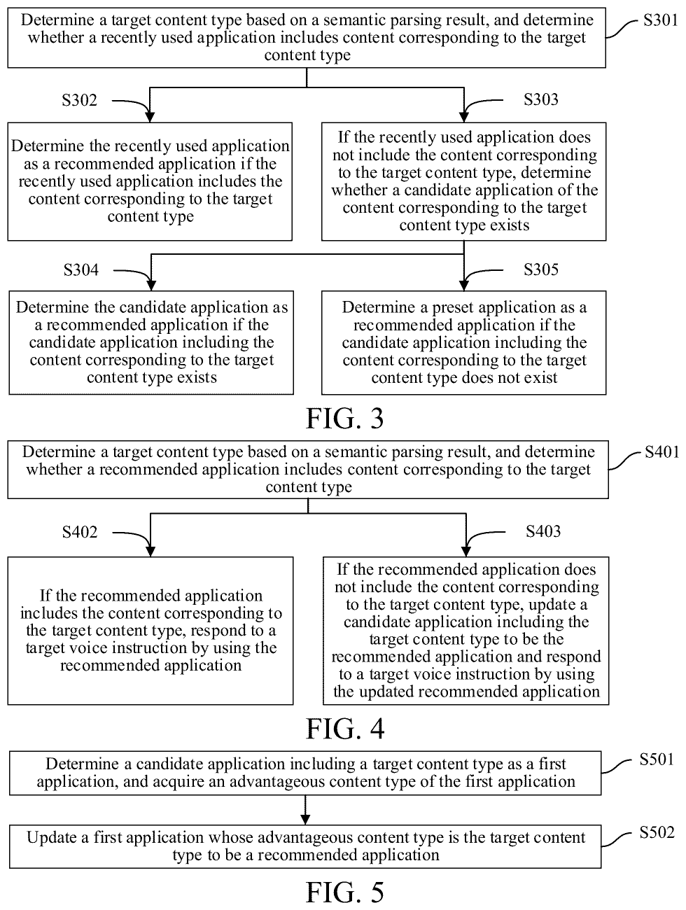

In some embodiments, as shown in FIG. 3, step S203, that the recommended application is determined from the application list by using the second recommendation policy includes the following steps.

S301: A target content type is determined based on the semantic parsing result, and whether the recently used application includes content corresponding to the target content type is determined.

S302: The recently used application is determined as the recommended application if the recently used application includes the content corresponding to the target content type.

S303: If the recently used application does not include the content corresponding to the target content type, whether a candidate application of the content corresponding to the target content type exists is determined.

S304: The candidate application is determined as the recommended application if the candidate application including the content corresponding to the target content type exists.

S305: The preset application is determined as the recommended application if the candidate application including the content corresponding to the target content type does not exist.

The target content type is a content type recognized in the semantic parsing result, in other words, is a content type recognized based on the target voice instruction. The semantic parsing result acquired through parsing by using the voice recognition tool includes not only the target service type corresponding to the service field, but also the target content type corresponding to a semantic field. Target service type analysis may be performed based on the target service type and the target content type. The semantic field is a field used to distinguish between utterances of different sub-categories under the service field, and is used to implement a different content type. For example, the service field internetRadio is further divided into several semantic fields: a program field, a tags field, a category field, and a presenter field. It may be understood that a different utterance of the user in the semantic parsing result indicates a different target content type corresponding to the semantic field in the semantic parsing result. For example, if the semantic parsing result is “listen to comedic radio stations”, the category field is filled. For another example, if the semantic parsing result is “listen to crosstalk by XX”, the presenter field is filled.

In an example, in step S301, when the multimedia system needs to analyze the recently used application by using the second recommendation policy, the multimedia system needs to first determine the target content type based on the semantic parsing result, and further determine whether the recently used application includes the content corresponding to the target content type, to determine whether the recently used application can meet a user requirement.

In an example, in step S302, when the recently used application includes the content of the target content type in the multimedia system, it indicates that the recently used application can display the content, of the target content type, required by the user. In addition, the recently used application is an application that has been used by the user in the preset period before the current moment, and reflects the user preference to a certain extent. Therefore, the recently used application may be determined as the recommended application, so that subsequently using the recommended application to respond to the target voice instruction better complies with the user preference.

In an example, in step S303, when the recently used application does not include the content of the target content type in the multimedia system, it indicates that the recently used application cannot display the content, of the target content type, required by the user. In this case, whether a candidate application other than the recently used application includes the content of the target content type needs to be determined from the at least one candidate application corresponding to the target service type determined based on the semantic parsing result, to determine the recommended application based on a determining result.

In an example, in step S304, when the candidate application including the content corresponding to the target content type exists in the multimedia system, it indicates that a service type of the candidate application includes the target service type determined based on the semantic parsing result, and the candidate application includes the content of the target content type determined based on the semantic parsing result, so that content that meets the user requirement can be displayed. Therefore, the candidate application may be determined as the recommended application.

In an example, in step S305, when the candidate application including the content corresponding to the target content type does not exist in the multimedia system, it indicates that a candidate application that meets both the target service type and the target content type does not exist. In this case, the preset application may be determined as the recommended application. The preset application is any one of the candidate application, and corresponds to the target service type. In this way, a recommended application that meets the basic user requirement is acquired.

In this embodiment, selection is performed sequentially from the recently used application, the candidate application including the target content type, and the preset application based on whether an application includes the content of the target content type, to determine the recommended application, so that the determined recommended application can meet the user preference to the greatest extent. In this way, using the recommended application to respond to the target voice instruction better complies with the user preference, and further improves the user retention rate.

In some embodiments, as shown in FIG. 4, step S105, that the target voice instruction is responded to by using the recommended application includes the following steps.

S401: The target content type is determined based on the semantic parsing result, and whether the recommended application includes the content corresponding to the target content type is determined.

S402: If the recommended application includes the content corresponding to the target content type, the target voice instruction is responded to by using the recommended application.

S403: If the recommended application does not include the content corresponding to the target content type, a candidate application including the target content type is updated to be the recommended application and the target voice instruction is responded to by using the updated recommended application.

The target content type is a content type recognized in the semantic parsing result, in other words, is a content type recognized based on the target voice instruction. The semantic parsing result acquired through parsing by using the voice recognition tool includes not only the target service type corresponding to the service field, but also the target content type corresponding to the semantic field. Target service type analysis may be performed based on the target service type and the target content type. The semantic field is a field used to distinguish between utterances of different sub-categories under the service field, and is used to implement a different content type.

In an example, in step S401, when the multimedia system responds to the target voice instruction by using the recommended application, the multimedia system may first determine the target content type based on the semantic parsing result, and further determine whether the recommended application includes the content of the target content type, to determine whether the recommended application can meet the content, of the target content type, required by the user.

In an example, in step S402, when the recommended application includes the content corresponding to the target content type, the multimedia system considers that the recommended application can display the content required by the user. In addition, the recommended application is an application with a high user preference degree. Therefore, the recommended application may be used to respond to the target voice instruction, to display the content of the target content type, so that the user preference is better met, and the user retention rate is further improved. For example, the target content type determined based on the target voice instruction is “play a song 1”. If the recommended application includes the song 1, the recommended application may be used to play the song 1. In this way, when content required by the user is displayed, the recommended application that meets the user preference may be used for display, so that the user preference is better complied with, and the user retention rate is further improved.

In an example, in step S403, when the recommended application does not include the content corresponding to the target content type, the multimedia system considers that the recommended application cannot display the content required by the user. In this way, the multimedia system may update the candidate application including the target content type to be the recommended application, and respond to the target voice instruction by using the updated recommended application, so that the updated recommended application can display the content of the target content type, and the user retention rate is further improved. For example, the target content type determined based on the target voice instruction is “play a song 1”. If the recommended application does not include the song 1, a candidate application including the song 1 is determined from the at least one candidate application in the application list, the candidate application includes the song 1 is updated to be the recommended application, and the song 1 is played by using the updated recommended application, so that the updated recommended application displays content required by the user, and the user retention rate is further improved.

In this embodiment, whether the recommended application needs to be updated is determined based on whether the recommended application includes the content of the target content type, to ensure that the recommended application can display the content required by the user, so that when the system responds, the user requirement can be met, and the user retention rate can be further improved.

In some embodiments, as shown in FIG. 5, step S403, that a candidate application including the target content type is updated to be the recommended application includes the following steps.

S501: The candidate application including the target content type is determined as a first application, and an advantageous content type of the first application is acquired.

S502: A first application whose advantageous content type is the target content type is updated to be the recommended application.

The first application is a candidate application including the target content type, in other words, the first application is an application that matches both the target service type and the target content type that are determined based on the semantic parsing result. The advantageous content type is a content type with a high user evaluation, and may be understood as a content type with a high user evaluation or frequent user access.

In an example, in step S501, the multimedia system may determine, from the application list, at least one candidate application including the target content type as a first application, so that the first application matches the target service type and the target content type that are determined based on the semantic parsing result, to ensure that the first application can display the content required by the user. In addition, after determining the first application, the multimedia system further needs to acquire an advantageous content type of the first application. For example, the multimedia system may query a preset advantageous content type information table, to determine the advantageous content type of the first application.

In an example, in step S502, after acquiring the advantageous content type of the at least one first application, the multimedia system may perform matching on the advantageous content type and the target content type determined based on the semantic parsing result, and update the first application whose advantageous content type is the target content type to be the recommended application, to use the updated recommended application to respond to the target voice instruction, so as to display the content corresponding to the target content type. Because the target content type is the advantageous content type of the updated recommended application, it indicates that a user evaluation of the target content type is high, and the user is more easily attracted, so that the user retention rate and the user experience are improved.

In this example, if a quantity of first applications whose advantageous content types are the target content type is at least two, user ratings of the at least two first applications for the target content type are acquired, and a first application with a highest user rating is determined as the recommended application, to ensure that the user is more easily attracted when the updated recommended application displays the content of the target content type, and therefore improve the user retention rate and the user experience.

In this embodiment, the at least one candidate application including the target content type is determined as the first application, and the first application whose advantageous content type is the target content type is updated to be the recommended application, so that the user is more easily attracted when the updated recommended application displays the content of the target content type, and therefore the user retention rate and the user experience are improved.

In an embodiment, the semantic parsing result includes the target content type.

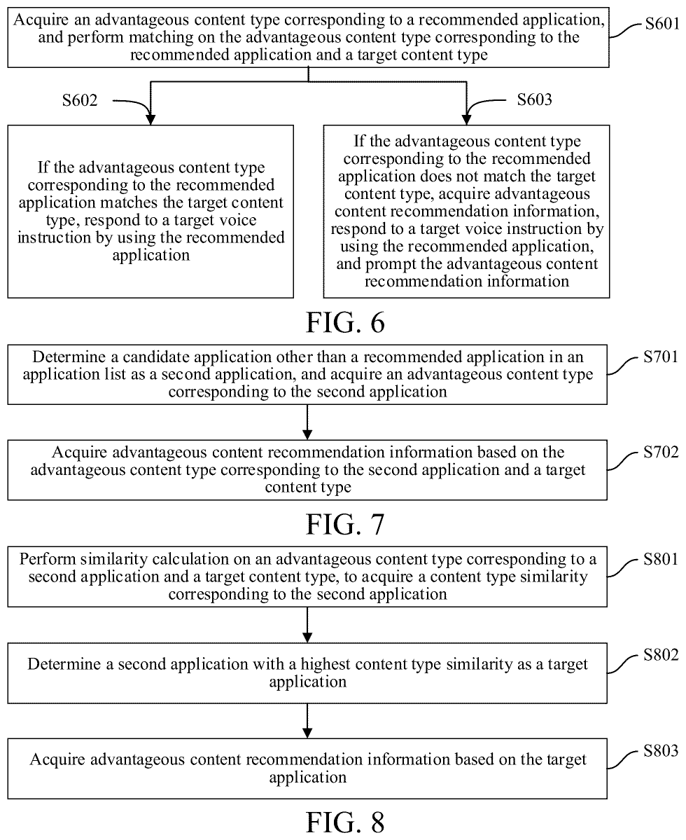

As shown in FIG. 6, step S105, in some embodiments, that the target voice instruction is responded to by using the recommended application includes the following steps.

S601: An advantageous content type corresponding to the recommended application is acquired, and matching is performed on the advantageous content type corresponding to the recommended application and the target content type.

S602: If the advantageous content type corresponding to the recommended application matches the target content type, the target voice instruction is responded to by using the recommended application.

S603: If the advantageous content type corresponding to the recommended application does not match the target content type, advantageous content recommendation information is acquired, the target voice instruction is responded to by using the recommended application, and the advantageous content recommendation information is prompted.

The target content type is a content type recognized in the semantic parsing result, in other words, is a content type recognized based on the target voice instruction. The semantic parsing result acquired through parsing by using the voice recognition tool includes not only the target service type corresponding to the service field, but also the target content type corresponding to the semantic field. Target service type analysis may be performed based on the target service type and the target content type. The semantic field is a field used to distinguish between utterances of different sub-categories under the service field, and is used to implement a different content type. The advantageous content type is a content type with a high user evaluation, and may be understood as a content type whose user evaluation meets a preset standard.

In an example, in step S601, when the multimedia system responds to the target voice instruction by using the recommended application, and in particular, responds to the target voice instruction by using the recently used application, the multimedia system needs to query an advantageous content type information table preset in the system, and determine the advantageous content type of the recommended application. The advantageous content type may be understood as a high-quality program of the recommended application, for example, a comedy program. In this example, the multimedia system may further perform matching on the advantageous content type of the recommended application and the target content type in the semantic parsing result, to determine, based on an analysis result, content that needs to be displayed in the recommended application.

In an example, in step S602, when the advantageous content type matches the target content type, the multimedia system may determine that the target content type that the user is interested in is the advantageous content type in the recommended application, for example, is the high-quality program in the recommended application. In this way, the multimedia system responds to the target voice instruction by using the recommended application, so that the user is more easily attracted, and the user retention rate is improved.

The advantageous content recommendation information is related information of an application whose advantageous content type is the target content type.

In an example, in step S603, when the advantageous content type does not match the target content type, the multimedia system determines that the target content type that the user is interested in is not the advantageous content type in the recommended application, for example, is not the high-quality program in the recommended application. In this way, the multimedia system may compare an advantageous content type of a candidate application other than the recommended application with the target content type to acquire the advantageous content recommendation information, then respond to the target voice instruction by using the recommended application, and prompt the advantageous content recommendation information. In one aspect, the target voice instruction can be responded to by using the recommended application, so that the user is attracted, and the user retention rate is improved. In another aspect, the user can also be enabled to learn of the advantageous content recommendation information, so as to determine whether an application whose advantageous content type matches the target content type needs to be used to respond to the target voice instruction, and the user retention rate can be further improved.

As shown in FIG. 10, the multimedia system may determine the recently used application as a recommended application APP1, and perform matching on the target content type (content of the semantic field) in the semantic parsing result and an advantageous content type of the recommended application APP1. If the target content type matches the advantageous content type of the recommended application APP1, the recommended application APP1 is used to respond to the target voice instruction. If the target content type does not match the advantageous content type of the recommended application APP1, matching is performed on the target content type (the content of the semantic field) and an advantageous content type of another candidate application in the application list. If there is a candidate application whose advantageous content type matches the target content type, the candidate application is determined as a target application APP2, advantageous content recommendation information (for example, APP2 has a higher-quality program) is generated, the recommended application APP1 is controlled to respond to the target voice instruction, and the advantageous content recommendation information (for example, APP2 has the higher-quality program) is displayed. If there is no candidate application whose advantageous content type matches the target content type, the recommended application APP1 is invoked to respond to the target voice instruction, and advantageous content recommendation information does not need to be prompted.

In the voice control method provided in this embodiment, whether the advantageous content recommendation information needs to be displayed in addition to using the recommended application to respond to the target voice instruction is determined based on a comparison result between the advantageous content type of the recommended application and the target content type of the semantic parsing result, so that the user preference is met, and the user retention rate is improved.

In some embodiments, as shown in FIG. 7, step S603, that advantageous content recommendation information is acquired includes the following steps.

S701: A candidate application other than the recommended application in the application list is determined as a second application, and an advantageous content type corresponding to the second application is acquired.

S702: The advantageous content recommendation information is acquired based on the advantageous content type corresponding to the second application and the target content type.

In an example, in step S701, the multimedia system may determine all candidate applications other than the recommended application in the application list as second applications, and then query the advantageous content type information table preset in the system to determine an advantageous content type of the second application.

In an example, in step S702, after acquiring the advantageous content type corresponding to the second application, the multimedia system may analyze and determine, based on the advantageous content type corresponding to the second application and the target content type determined based on the semantic parsing result, a second application corresponding to an advantageous content type that is most similar to the target content type, to form the corresponding advantageous content recommendation information based on the second application with the most similar advantageous content type. The advantageous content recommendation information is used to display information about the advantageous content type, in the second application, that is most similar to the target content type, so that the user is enabled to learn of the advantageous content recommendation information and is reminded whether the second application with the most similar advantageous content type needs to be used to respond to the target voice instruction, and the user retention rate can be further improved.

In this embodiment, when the advantageous content type corresponding to the recommended application does not match the target content type, the candidate application other than the recommended application may be determined as the second application, to avoid repeated calculation. This helps save computational resources and improve processing efficiency. The advantageous content recommendation information is formed based on the target content type and the advantageous content type corresponding to the second application, so that the user is enabled to learn of the advantageous content recommendation information, so as to determine whether the second application with the most similar advantageous content type needs to be used to respond to the target voice instruction, and the user retention rate can be further improved.

In some embodiments, as shown in FIG. 8, step S702, that the advantageous content recommendation information is acquired based on the advantageous content type corresponding to the second application and the target content type includes the following steps.

S801: Similarity calculation is performed on the advantageous content type corresponding to the second application and the target content type, to acquire a content type similarity corresponding to the second application.

S802: A second application with a highest content type similarity is determined as a target application.

S803: The advantageous content recommendation information is acquired based on the target application.

In an example, in step S801, after acquiring all the second applications, the multimedia system may perform similarity calculation on advantageous content types corresponding to the second applications and the target content type by using, but not limited to, a cosine similarity algorithm, to acquire a content type similarity of each second application. The content type similarity is used to reflect a similarity between the target content type and the advantageous content type.

In an example, in step S802, after acquiring content type similarities corresponding to all the second applications, the multimedia system may compare all the content type similarities, and determine the second application with the highest content type similarity as the target application. The target application herein may be understood as a candidate application whose advantageous content type is the most similar to the target content type. In other words, the target application meets the basic user requirement corresponding to the target service type, and can ensure that a target content type of the target application is the advantageous content type. This helps improve a user preference degree, and further improve the user retention rate.

In an example, in step S803, after determining the target application, the multimedia system may fill a preset recommendation information template with a program name or another unique identifier corresponding to the target application, to acquire the advantageous content recommendation information, so that the user is enabled to learn of the advantageous content recommendation information, so as to determine whether an application whose advantageous content type matches the target content type needs to be used to respond to the target voice instruction, and the user retention rate can be further improved.

In this embodiment, the second application with the highest content type similarity corresponding to the target content type and the advantageous content type is selected and is determined as the target application, to form the advantageous content recommendation information, so that the basic user requirement corresponding to the target service type can be met, and it can also be ensured that the target content type of the target application is the advantageous content type. This helps improve the user preference degree, and further improve the user retention rate.

In an embodiment, the application list includes at least one candidate application, and each candidate application includes at least one current content type.

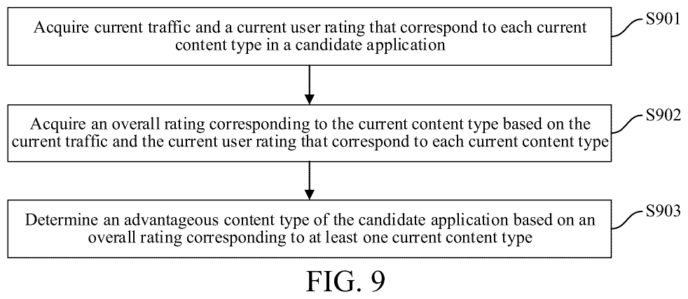

As shown in FIG. 9, before step S105, in some embodiments, that the target voice instruction is responded to by using the recommended application, the voice control method further includes the following steps.

S901: Current traffic and a current user rating that correspond to each current content type in the candidate application are acquired.

S902: An overall rating corresponding to the current content type is acquired based on the current traffic and the current user rating that correspond to each current content type.

S903: An advantageous content type of the candidate application is determined based on an overall rating corresponding to the at least one current content type.

The candidate application is an application in the application list, and is an application corresponding to the target service type. The current content type is a content type set by the candidate application at the current moment, for example, includes but is not limited to crosstalk, a sketch, or another content type.

In an example, in step S901, the multimedia system may further acquire, through real-time statistics collection, current traffic and a current user rating that correspond to each current content type in each candidate application. The current traffic is traffic in the preset period before the current moment, may reflect a quantity of users that access the current content type in the preset period before the current moment, and may reflect, to a certain extent, a user preference degree for content of the current content type. The current user rating is a rating value at the current moment, or may be limited to a rating value in the preset period before the current moment, and reflects the user preference degree for the content of the current content type.

In an example, in step S902, after acquiring the current traffic and the current user rating that correspond to each current content type, the multimedia system may perform weighting or other calculation on the current traffic and the current user rating, to determine an overall rating corresponding to the current content type. For example, the multimedia system may first perform normalization on the current traffic and the current user rating to respectively acquire a traffic normalization value and a rating normalization value, and then perform weighting with reference to a preset traffic weight and a preset rating weight to acquire the overall rating corresponding to each current content type, so that the overall rating can reflect the user preference degree for the content of the current content type or a positive reception degree for the content of the current content type.

In an example, in step S903, after receiving an overall rating corresponding to at least one current content type, the multimedia system may process the overall rating by using a preset advantage evaluation condition, and determine an advantageous content type of the to-be-processed application from the at least one current content type. For example, the multimedia system may determine, as the advantageous content type of the to-be-processed application, a current content type whose overall rating is greater than a preset rating. The preset rating herein is a preset rating used to evaluate whether an advantageous content type standard is met. For another example, the multimedia system may determine, as advantageous content types of the to-be-processed application, first N current content types with high overall ratings. N≥1.

In this embodiment, before the recommended application is used to respond to the target voice instruction, the overall rating of each current content type may be determined based on the current traffic and the current user rating that correspond to the current content type, to update an advantageous content type corresponding to each to-be-processed application, so that when the to-be-processed application (including but not limited to the recommended application) is used to respond to the target voice instruction based on the advantageous content type of the to-be-processed application, the user preference is better met. This helps improve the user preference degree, and further improve the user retention rate.

It should be understood that sequence numbers of steps do not mean execution sequences in the foregoing embodiments. Execution sequences of processes should be determined based on functions and internal logic of the processes, and should not limit on implementation processes of embodiments of the present disclosure.

In an embodiment, a multimedia system is provided. The multimedia system includes a memory, a processor, and a computer program stored in the memory and running on the processor. The voice control method in the foregoing embodiment, for example, S101 to S105 shown in FIG. 1 or the steps shown in FIG. 2 to FIG. 8, is implemented when the processor executes the computer program. To avoid repetition, details are not described herein again.

In an embodiment, a vehicle is provided. The vehicle includes the multimedia system in the foregoing embodiment. The multimedia system may perform the voice control method in the foregoing embodiment, for example, S101 to S105 shown in FIG. 1 or the steps shown in FIG. 2 to FIG. 8. To avoid repetition, details are not described herein again.

In an embodiment, a non-transitory computer-readable storage medium is provided. The non-transitory computer-readable storage medium stores a computer program. The voice control method in the foregoing embodiment, for example, S101 to S105 shown in FIG. 1 or the steps shown in FIG. 2 to FIG. 8, is implemented when the computer program is executed by a processor. To avoid repetition, details are not described herein again.

A person of ordinary skill in the art may understand that all or some of procedures of the method in the foregoing embodiments may be implemented by a computer program instructing related hardware. The computer program may be stored in a non-volatile computer-readable storage medium. When the computer program is executed, the procedures of the foregoing method embodiments may be included. References to the memory, the storage, the database, or another medium used in the embodiments provided in the present disclosure may all include a non-volatile memory and/or a volatile memory. The non-volatile memory may include a read-only memory (ROM), a programmable ROM (PROM), an electrically programmable ROM (EPROM), an electrically erasable programmable ROM (EEPROM), or a flash memory. The volatile memory may include a random access memory (RAM) or an external cache. By way of description, and not limitation, the RAM may be acquired in multiple forms, such as a static RAM (SRAM), a dynamic RAM (DRAM), a synchronous DRAM (SDRAM), a double data rate SDRAM (DDRSDRAM), an enhanced SDRAM (ESDRAM), a synchlink (Synchlink) DRAM (SLDRAM), a rambus (Rambus) direct RAM (RDRAM), a direct rambus dynamic RAM (DRDRAM), and a rambus dynamic RAM (RDRAM).

A person skilled in the art may clearly understand that, for the purpose of convenient and brief description, division into the foregoing functional units or modules is merely used as an example for description. During actual application, the foregoing functions may be allocated to different functional units or modules for implementation based on a requirement. In other words, an inner structure of the apparatus is divided into different functional units or modules to implement all or some of the functions described above.

The foregoing embodiments are merely for describing the technical solutions of the present disclosure, but not for limiting the present disclosure. Although the present disclosure is described in detail with reference to the foregoing embodiments, it should be understood by a person of ordinary skill in the art: Modifications may still be made to the technical solutions described in the foregoing embodiments, or equivalent replacements may still be made to some of the technical features. These modifications or replacements do not cause essence of the corresponding technical solutions to depart from the spirit and scope of the technical solutions of the embodiments of the present disclosure, and shall fall within the protection scope of the present disclosure.

What is claimed is:

1. A voice control method, comprising:
receiving, by a processor of a voice control system, a target voice instruction;
performing, by the processor, semantic parsing on the target voice instruction, and acquiring a semantic parsing result; and
in response to that the semantic parsing result matches a keyword, responding, by the processor, to the target voice instruction by using an application corresponding to the keyword; or
in response to that the semantic parsing result does not match a keyword, determining, by the processor, a target service type based on the semantic parsing result, and acquiring, by the processor, an application list corresponding to the target service type; determining, by the processor, a recommended application from the application list by using a first recommendation policy; and responding, by the processor, to the target voice instruction by using the recommended application.

2. The voice control method according to claim 1, wherein the determining, by the processor, a recommended application from the application list by using a first recommendation policy comprises:
in response to that the application list comprises a foreground application, determining the foreground application as the recommended application;
in response to that the application list does not comprise a foreground application and the application list comprises a background application, determining the background application as the recommended application;
in response to that the application list does not comprise a foreground application and a background application and the application list comprises a recently used application, determining the recommended application from the application list by using a second recommendation policy; and
in response to that the application list does not comprise a foreground application, a background application, and a recently used application, determining a preset application as the recommended application,
wherein the recently used application comprises an application used in a period before a current moment.

3. The voice control method according to claim 2, wherein the determining the recommended application from the application list by using a second recommendation policy comprises:
determining a target content type based on the semantic parsing result, and determining whether the recently used application comprises content corresponding to the target content type; and
in response to that the recently used application comprises the content corresponding to the target content type, determining the recently used application as the recommended application; or
in response to that the recently used application does not comprise the content corresponding to the target content type, determining whether a candidate application of the content corresponding to the target content type exists; and determining the candidate application as the recommended application in response to that the candidate application comprising the content corresponding to the target content type exists, or determining the preset application as the recommended application in response to that the candidate application comprising the content corresponding to the target content type does not exist.

4. The voice control method according to claim 3, wherein the responding to the target voice instruction by using the recommended application comprises:
determining the target content type based on the semantic parsing result, and determining whether the recommended application comprises the content corresponding to the target content type; and
in response to that the recommended application comprises the content corresponding to the target content type, responding to the target voice instruction by using the recommended application; or
in response to that the recommended application does not comprise the content corresponding to the target content type, obtaining a candidate application comprising the target content type, determining the candidate application as the recommended application, and responding to the target voice instruction by using the recommended application.

5. The voice control method according to claim 4, wherein the obtaining a candidate application comprising the target content type, and determining the candidate application as the recommended application comprises:
determining a plurality of candidate applications, and acquiring an advantageous content type of each of the candidate applications; and
selecting, from the candidate applications, a first application having an advantageous content type that is the target content type as the recommended application.

6. The voice control method according to claim 3, wherein the semantic parsing result comprises the target content type; and
the responding, by the processor, to the target voice instruction by using the recommended application comprises:
acquiring an advantageous content type corresponding to the recommended application, and matching the advantageous content type corresponding to the recommended application with the target content type; and
in response to that the advantageous content type corresponding to the recommended application matches the target content type, responding to the target voice instruction by using the recommended application; or in response to that the advantageous content type corresponding to the recommended application does not match the target content type, acquiring advantageous content recommendation information, responding to the target voice instruction by using the recommended application, and prompting the advantageous content recommendation information.

7. The voice control method according to claim 6, wherein the acquiring advantageous content recommendation information comprises:
determining a plurality of candidate applications other than the recommended application in the application list as second applications, and acquiring an advantageous content type corresponding to each of the second applications; and
acquiring the advantageous content recommendation information based on the target content type and the advantageous content type corresponding to each of the second applications.

8. The voice control method according to claim 7, wherein the acquiring the advantageous content recommendation information based on the target content type and the advantageous content type corresponding to each of the second applications comprises:
performing similarity calculation on the target content type and the advantageous content type corresponding to each of the second applications, and acquiring a content type similarity corresponding to each of the second applications;
determining, from the second applications, a second application with a highest content type similarity as a target application; and
acquiring the advantageous content recommendation information based on the target application.

9. The voice control method according to claim 6, wherein the application list comprises at least one candidate application, and each of the at least one candidate application comprises at least one current content type; and
before the responding to the target voice instruction by using the recommended application, the voice control method further comprises:
acquiring current traffic and a current user rating that correspond to each of the at least one current content type in the at least one candidate application;
acquiring, based on the current traffic and the current user rating that correspond to each of the at least one current content type, an overall rating corresponding to the at least one current content type; and
determining an advantageous content type of the at least one candidate application based on an overall rating corresponding to the at least one current content type.

10. A voice control system, comprising a memory, a processor, and a computer program stored in the memory, wherein the processor is configured to execute the computer program to perform operations comprising:
receiving a target voice instruction;
performing semantic parsing on the target voice instruction, and acquiring a semantic parsing result; and
in response to that the semantic parsing result matches a keyword, responding to the target voice instruction by using an application corresponding to the keyword; or
in response to that the semantic parsing result does not match a keyword, determining a target service type based on the semantic parsing result, and acquiring an application list corresponding to the target service type; determining a recommended application from the application list by using a first recommendation policy; and responding to the target voice instruction by using the recommended application.

11. The system according to claim 10, wherein the determining a recommended application from the application list by using a first recommendation policy comprises:
in response to that the application list comprises a foreground application, determining the foreground application as the recommended application;
in response to that the application list does not comprise a foreground application and the application list comprises a background application, determining the background application as the recommended application;
in response to that the application list does not comprise a foreground application and a background application and the application list comprises a recently used application, determining the recommended application from the application list by using a second recommendation policy; and
in response to that the application list does not comprise a foreground application, a background application, and a recently used application, determining a preset application as the recommended application,
wherein the recently used application comprises an application used in a period before a current moment.

12. The system according to claim 11, wherein the determining the recommended application from the application list by using a second recommendation policy comprises:
determining a target content type based on the semantic parsing result, and determining whether the recently used application comprises content corresponding to the target content type; and
in response to that the recently used application comprises the content corresponding to the target content type, determining the recently used application as the recommended application; or
in response to that the recently used application does not comprise the content corresponding to the target content type, determining whether a candidate application of the content corresponding to the target content type exists; and determining the candidate application as the recommended application in response to that the candidate application comprising the content corresponding to the target content type exists, or determining the preset application as the recommended application in response to that the candidate application comprising the content corresponding to the target content type does not exist.

13. The system according to claim 12, wherein the responding to the target voice instruction by using the recommended application comprises:
determining the target content type based on the semantic parsing result, and determining whether the recommended application comprises the content corresponding to the target content type; and
in response to that the recommended application comprises the content corresponding to the target content type, responding to the target voice instruction by using the recommended application; or
in response to that the recommended application does not comprise the content corresponding to the target content type, obtaining a candidate application comprising the target content type, determining the candidate application as the recommended application, and responding to the target voice instruction by using the recommended application.

14. The system according to claim 13, wherein the obtaining a candidate application comprising the target content type, and determining the candidate application as the recommended application comprises:
determining a plurality of candidate applications, and acquiring an advantageous content type of each of the candidate applications; and
selecting, from the candidate applications, a first application having an advantageous content type that is the target content type as the recommended application.

15. The system according to claim 12, wherein the semantic parsing result comprises the target content type; and
the responding, by the processor, to the target voice instruction by using the recommended application comprises:
acquiring an advantageous content type corresponding to the recommended application, and matching the advantageous content type corresponding to the recommended application with the target content type; and
in response to that the advantageous content type corresponding to the recommended application matches the target content type, responding to the target voice instruction by using the recommended application; or in response to that the advantageous content type corresponding to the recommended application does not match the target content type, acquiring advantageous content recommendation information, responding to the target voice instruction by using the recommended application, and prompting the advantageous content recommendation information.

16. The system according to claim 15, wherein the acquiring advantageous content recommendation information comprises:
determining a plurality of candidate applications other than the recommended application in the application list as second applications, and acquiring an advantageous content type corresponding to each of the second applications; and
acquiring the advantageous content recommendation information based on the target content type and the advantageous content type corresponding to each of the second applications.

17. The system according to claim 16, wherein the acquiring the advantageous content recommendation information based on the target content type and the advantageous content type corresponding to each of the second applications comprises:
performing similarity calculation on the target content type and the advantageous content type corresponding to each of the second applications, and acquiring a content type similarity corresponding to each of the second applications;
determining, from the second applications, a second application with a highest content type similarity as a target application; and
acquiring the advantageous content recommendation information based on the target application.

18. The system according to claim 15, wherein the application list comprises at least one candidate application, and each of the at least one candidate application comprises at least one current content type; and
before the responding to the target voice instruction by using the recommended application, the operations further comprise:
acquiring current traffic and a current user rating that correspond to each of the at least one current content type in the at least one candidate application;
acquiring, based on the current traffic and the current user rating that correspond to each of the at least one current content type, an overall rating corresponding to the at least one current content type; and
determining an advantageous content type of the at least one candidate application based on an overall rating corresponding to the at least one current content type.

19. A vehicle, comprising the voice control system according to claim 10.

20. A non-transitory computer-readable storage medium, storing a computer program, wherein the computer program, when executed by a processor, causes the processor to perform operations comprising:
receiving a target voice instruction;
performing semantic parsing on the target voice instruction, and acquiring a semantic parsing result; and
in response to that the semantic parsing result matches a keyword, responding to the target voice instruction by using an application corresponding to the keyword; or
in response to that the semantic parsing result does not match a keyword, determining a target service type based on the semantic parsing result, and acquiring an application list corresponding to the target service type; determining a recommended application from the application list by using a first recommendation policy; and responding to the target voice instruction by using the recommended application.
